(19) United States
(12) Patent Application Publication
(10) Pub. No.: US 2014/0307308 A1
(43) Pub. Date: Oct. 16, 2014

(54) Reflective Optical Element for the EUV Wavelength Range, Method for Producing and for Correcting Such an Element, Projection Lens for Microlithography Comprising Such an Element, and Projection Exposure Apparatus for Microlithography Comprising Such a Projection Lens

(71) Applicant: Carl Zeiss SMT GmbH, Oberkochen (DE)

(72) Inventors: Markus WEISS, Aalen (DE); Norbert KERWIEN, Moegglingen (DE); Martin WEISER, Sinsheim (DE); Boris BITTNER, Roth (DE); Norbert WABRA, Werneck (DE); Christoph SCHLICHENMAIER, Oberkochen (DE); Wilfried CLAUSS, Ulm (DE)

(73) Assignee: Carl Zeiss SMT GmbH, Oberkochen (DE)

(21) Appl. No.: 14/246,489

(22) Filed: Apr. 7, 2014

Related U.S. Application Data
(63) Continuation of application No. PCT/EP2012/065838, filed on Aug. 14, 2012.

(30) Foreign Application Priority Data
Oct. 7, 2011 (DE) 102011084117.2

(51) Int. Cl. G02B 5/08; B29D 11/00; G02B 13/14

(52) U.S. Cl. CPC G02B 5/0891; G02B 13/143; B29D 11/00009; B29D 11/00865
USPC 359/355; 359/359; 427/8; 264/1.36

(57) ABSTRACT

A reflective optical element 39 for EUV wavelengths having a layer arrangement on the surface of a substrate, wherein the layer arrangement includes at least one layer subsystem 37 consisting of a periodic sequence of at least one period of individual layers. The period includes two individual layers having different refractive indices in the EUV wavelength range. The substrate has a variation of the density of more than 1% by volume at least along an imaginary surface 30 at a fixed distance of between 0 μm and 100 μm from the surface. Also, the substrate is protected against long-term aging or densification by EUV radiation either with a protective layer, with a protective layer subsystem of the layer arrangement, or with a correspondingly densified surface region 35 of the substrate.

### CROSS-REFERENCE TO RELATED APPLICATIONS

This application is a Continuation Application of International Application No. PCT/EP2012/065838, filed on Aug. 14, 2012, which claims benefit under 35 U.S.C 119(e) of U.S. Provisional Application No. 61/544,361, filed Oct. 7, 2011, and which claims priority under 35 U.S.C. §119(a) to German Patent Application No. 10 2011 084 117.2, filed Oct. 7, 2011. The entire disclosures of all three related applications are considered part of and are incorporated by reference into the disclosure of the present application.

### FIELD OF AND BACKGROUND OF THE INVENTION

The invention relates to a reflective optical element for the EUV wavelength range. Furthermore, the invention relates to a method for producing and to a method for correcting such an element. Furthermore, the invention relates to a projection lens for microlithography comprising such an element and to a projection exposure apparatus for microlithography comprising such a projection lens.

Projection exposure apparatuses for microlithography for the EUV wavelength range of 5-20 nm have to rely on the assumption that the reflective optical elements used for imaging a mask into an image plane have a high accuracy of their surface form. Masks as reflective optical elements for the EUV wavelength range should likewise have a high accuracy of their surface form since replacing them is manifested not inconsiderably in the operating costs of a projection exposure apparatus.

Methods for correcting the surface form of optical elements are known from: U.S. Pat. No. 6,844,272 B2, U.S. Pat. No. 6,849,859 B2, DE 102 39 859 A1, U.S. Pat. No. 6,821,682 B1, US 2004 0061868 A1, US 2003 0006214 A1, US 2003 00081722 A1, U.S. Pat. No. 6,898,011 B2, U.S. Pat. No. 7,083,290 B2, U.S. Pat. No. 7,189,655 B2, US 2003 0058986 A1, DE 10 2007 051 291 A1, EP 1 521 155 A2 and U.S. Pat. No. 4,298,247.

Some of the correction methods presented in said patent specifications are based on locally densifying the substrate material of optical elements by irradiation. This results in a change in the surface form of the optical element in the vicinity of the irradiated regions. Other methods are based on direct surface removal of the optical element. Still others of the methods mentioned use the thermal or electrical deformability of materials, to impress spatially extended surface form changes on the optical elements.

What is disadvantageous about all of the methods mentioned, however, is that they do not take account of the long-term densification or ageing of the substrate material of the order of magnitude of a few % by volume on account of EUV radiation. Consequently, an optical element corrected by these methods has an impermissible surface form in the long term, especially as the optical elements in general are not subjected to the EUV radiation uniformly during operation and, therefore, the ageing is non-uniform and delimited in part very locally to specific regions of the optical element.

A cause of the densification or ageing of substrate materials, such as, for example, Zerodur® from Schott AG or ULE® from Corning Inc. having a proportion of more than 40% by volume SiO₂, is assumed to be the fact that at the high production temperatures of the substrate material an imbalance state is thermodynamically frozen, which undergoes transition to a thermodynamic ground state during EUV irradiation. In line with this hypothesis it is possible to produce coatings composed of SiO₂ which exhibit no such densification, since, with a correspondingly chosen coating method, these layers are produced at significantly lower temperatures than the substrate material.

### OBJECTS AND SUMMARY OF THE INVENTION

Therefore, it is an object of the invention to provide a reflective optical element for the EUV wavelength range, a method for producing said reflective optical element, and a method for correcting the surface form deviation of said reflective optical element, such that the surface form of said reflective optical element exhibits long-term stability under EUV radiation.

According to one formulation of the invention, this object is achieved by a reflective optical element for the EUV wavelength range comprising a layer arrangement applied on a surface of a substrate, wherein the layer arrangement comprises at least one layer subsystem consisting of a periodic sequence of at least one period of individual layers, wherein the period comprises two individual layers having different refractive indices in the EUV wavelength range, wherein the substrate in a surface region adjoining the layer arrangement with an extent of up to a distance of 5 μm from the surface has an average density which is higher by more than 1% by volume than the average density of the substrate at a distance of 1 mm from the surface, and in that the substrate has a variation of the density of more than 1% by volume at least along an imaginary surface at a fixed distance of between 1 μm and 100 μm from the surface.

In one embodiment, the average density in the surface region at an extent of up to a distance of 1 μm from the surface is higher by more than 2% by volume than the average density of the substrate at a distance of 1 nm from the surface. A surface region of the substrate densified in this way is no longer densified or aged further by EUV radiation. In this case, it should be taken into consideration that, in the case of reflective optical elements, the EUV radiation has only a penetration depth into the substrate of up to 5 μm and, consequently, it is enough to sufficiently densify only this region of the substrate in proximity to the surface.

Furthermore, the object of the present invention is achieved, according to another formulation, by a reflective optical element for the EUV wavelength range comprising a layer arrangement applied on the surface of a substrate, wherein the layer arrangement comprises at least one layer subsystem consisting of a periodic sequence of at least one period of individual layers, wherein the period comprises two individual layers having different refractive indices in the EUV wavelength range, wherein the layer arrangement comprises at least one protective layer or at least one protective layer subsystem having a thickness of greater than 20 nm, in particular 50 nm, such that the transmission of EUV radiation through the layer arrangement is less than 10%, in particular less than 2%, and in that the substrate has a variation of the density of more than 1% by volume at least along an imaginary surface at a fixed distance of between 0 μm and 100 μm from the surface.

According to the invention it has been recognized that a surface form correction—performed through irradiation—of a reflective optical element is preferably performed in regions of the substrate which are subjected only to low EUV radiation doses during operation and, on account of that, also do not change any more in terms of their density. Such correction regions are characterized by a variation of the density of more than 1% by volume along an imaginary surface at a fixed distance from the surface and are protected sufficiently against the EUV radiation either by a protective layer or a protective layer subsystem on the substrate surface or by an already sufficiently densified surface region with an extent of up to a distance of 5 μm below the surface.

In this case, it should be taken into consideration that the variation of the density along an imaginary surface at a fixed distance from the surface is understood to be the difference between the maximum density and the minimum density along the imaginary surface, and that this variation of the density arises as a result of a local irradiation of the substrate for correcting local surface form deviations—ascertained in interferometer data—of the optical element or for correcting wavefront deviations of the projection lens of the projection exposure apparatus. In contrast thereto, the density of the unirradiated substrate has a high homogeneity with a deviation from the average density of the substrate of less than 0.1% by volume in the entire volume of the substrate. Preferably, the density of the densified surface region also likewise has such a high homogeneity relative to the average density within the surface region, since otherwise different regions of the surface region exhibit different long-term stabilities relative to the EUV radiation. However, it may be appropriate under certain circumstances, to adapt the profile of the density within the densified surface region to the expected distribution of the EUV radiation dose over the mirror surface.

In one embodiment, the layer arrangement comprises at least one layer which is formed or made up as a compound from a material of the group: nickel, carbon, boron carbide, cobalt, beryllium, silicon, silicon oxides. These materials firstly have a sufficiently high absorption coefficient for EUV radiation and secondly do not change under EUV radiation.

In another embodiment, the layer arrangement comprises at least one protective layer subsystem consisting of a periodic sequence of at least two periods of individual layers, wherein the periods comprise two individual layers composed of different materials, wherein the materials of the two individual layers forming the periods are either nickel and silicon or cobalt and beryllium. Such layer stacks make it possible to prevent the crystal growth of the absorbent metals and thus to provide overall a lower roughness of the layers for the actual reflection coating than is possible in the case of pure metal protective layers having corresponding thickness.

In a further embodiment, the substrate has a variation of the density of more than 2% by volume at least along an imaginary surface at a fixed distance of between 1 μm and 5 μm from the surface. This distance range is firstly in sufficient proximity to the surface to have a sufficient surface form change of the substrate even in the case of a brief correction irradiation, and secondly is situated sufficiently within the substrate to be protected by a protective layer or protective layer system or a densified surface region.

In one embodiment, the substrate consists of a material having an SiO₂ proportion of at least 40% by volume up to a distance of 1 mm from the surface. This makes it possible to join together different materials for the substrate, wherein the topmost layer of the substrate toward the surface consists of a material having an SiO₂ proportion of at least 40% by volume.

In a further embodiment, the variation of the density of more than 1% by volume along an imaginary surface at a fixed distance between 1 μm and 100 μm from the surface of the substrate is produced with the aid of electrons having an energy of between 5 and 80 keV at doses of between 0.1 J/mm² and 2500 J/mm² and/or with the aid of a pulsed laser having wavelengths of between 0.3 and 3 μm, repetition rates of between 1 Hz and 100 MHz and pulse energies of between 0.01 μl and 10 mJ.

Furthermore, the object of the present invention according to yet another formulation of the invention, is achieved by a method for producing a reflective optical element, comprisings:

a) measuring the substrate surface with an interferometer;
b) irradiating the substrate with electrons having an energy of between 5 and 80 keV at doses of between 0.1 J/mm² and 2500 J/mm² and/or with a pulsed laser having wavelengths of between 0.3 and 3 μm, repetition rates of between 1 Hz and 100 MHz and pulse energies of between 0.01 μl and 10 mJ;
c) coating the substrate with a protective layer or a protective layer subsystem and/or irradiating the substrate with electrons having an energy of between 5 and 80 keV at doses of between 0.1 J/mm² and 4000 J/mm² and
d) coating the substrate with at least one layer subsystem suitable for the EUV wavelength range.

According to the invention, it has been recognized that, alongside a step b) for the surface form correction of the optical element, a step c) for the protective coating or protective irradiation of the optical element is also important in order to produce a mirror which is protected against long-term surface form deviations on account of the radiation-induced structural change of the substrate material under EUV radiation. In this case step b) for correcting the surface form deviations is carried out before the coating of the substrate with a reflective layer subsystem on the basis of the data of a measurement of the surface of the optical element with an interferometer. As a result, it is possible to use a laser for the local surface form change as an alternative or in addition to the electron irradiation in step b), since a laser generally cannot penetrate through the reflective coating of an optical element for the EUV wavelength range and the substrate of an EUV mirror generally has a thickness such that a form correction with the aid of a laser cannot be carried out from the rear side of the substrate.

In one embodiment variant, a higher energy of the electrons is used when irradiating the substrate with electrons in step b) than in step c). As a result, the regions of the substrate material for correcting the surface form deviation and for protective densification using electron beams are separated from one another on account of the different penetration depth. Furthermore, it may be necessary to carry out the protective irradiation with electrons in step c) at a higher dose of up to 4000 J/mm², in order to achieve a saturated densification which is no longer changed by subsequent EUV irradiation. During the irradiation for surface form correction with electrons in step b), by contrast, generally a dose of up to 2500 J/mm², suffices to perform a sufficient surface form correction.

Furthermore, the object of the present invention is achieved with a method for correcting the surface form of a reflective optical element, comprising:

a) measuring the reflective optical element with an interferometer and/or measuring a projection lens comprising the reflective optical element with an interferometer; and
b) irradiating the reflective optical element with electrons having an energy of between 5 and 80 keV at doses of between 0.1 J/mm² and 2500 J/mm².

According to the invention, it has been recognized that it is possible to perform the surface form correction of an already finished coated optical element for correcting the surface form deviation of the optical element or for correcting the wavefront deviation of an entire projection lens of a projection exposure apparatus with the aid of electrons in regions of the substrate below the layer arrangement. In this case, the layer arrangement of the optical element can already contain a protective layer or a protective layer subsystem. Furthermore, the substrate can already have a densified surface region for protection against EUV radiation. Alternatively, said surface region can be concomitantly produced at the same time during the electron irradiation for the surface form correction in step b).

Furthermore, the object of the invention is achieved with a projection lens comprising at least one mirror according to the invention.

Furthermore, the object of the invention is achieved with a projection exposure apparatus according to the invention for microlithography comprising such a projection lens.

Further features and advantages of the invention are evident from the following description of exemplary embodiments of the invention with reference to the figures, which show details essential to the invention, and from the claims. The individual features can be realized in each case individually by themselves or as a plurality in any desired combination in a variant of the invention.

### BRIEF DESCRIPTION OF THE DRAWINGS

Exemplary embodiments of the invention are explained in greater detail below with reference to the figures, in which:

FIG. 1 shows a schematic illustration of a projection lens according to the invention for a projection exposure apparatus for microlithography;

FIGS. 2A-2D show schematic illustrations of a first method according to the invention for producing a first optical element according to the invention, and

FIGS. 3A-3C show schematic illustrations of a second method according to the invention for correcting a second optical element according to the invention.

### DETAILED DESCRIPTION OF EXEMPLARY EMBODIMENTS

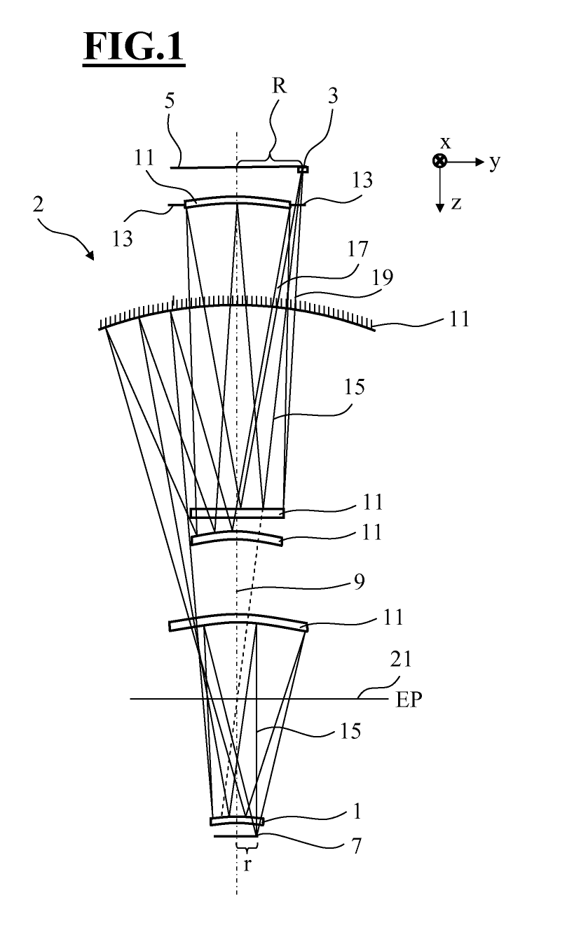

FIG. 1 shows a schematic illustration of a projection lens 2 according to the invention for a projection exposure apparatus for microlithography composing six mirrors 1, 11, including at least one mirror 1 as optical element according to the invention. The task of a projection exposure apparatus for microlithography is to image the structures of a mask, which is also designated as a reticle, lithographically onto a so-called wafer in an image plane. For this purpose, a projection lens 2 according to the invention in FIG. 1 images an object field 3, which is arranged in the object plane 5, into an image field in the image plane 7. The structure-bearing mask or mask according to the invention, which is not illustrated in the drawing for the sake of clarity, can be arranged at the location of the object field 3 in the object plane 5. For orientation purposes, FIG. 1 illustrates a cartesian coordinate system, the x-axis of which points into the plane of the figure. In this case, the x-y coordinate plane coincides with the object plane 5, the z-axis being perpendicular to the object plane 5 and pointing downward. The projection lens has an optical axis 9, which does not run through the object field 3. The mirrors 1, 11 of the projection lens 2 have a design surface that is rotationally symmetrical with respect to the optical axis. In this case, said design surface must not be confused with the physical surface of a finished mirror, since the latter is trimmed relative to the design surface in order to ensure passages of the light past the mirror. In this exemplary embodiment, the aperture stop 13 is arranged on the second mirror 11 in the light path from the object plane 5 to the image plane 7. The effect of the projection lens 2 is illustrated with the aid of three rays, the chief ray 15 and the two aperture marginal rays 17 and 19, all of which originate in the center of the object field 3. The chief ray 15, which runs at an angle of 6° with respect to the perpendicular to the object plane, intersects the optical axis 9 in the plane of the aperture stop 13. As viewed from the object plane 5, the chief ray 15 appears to intersect the optical axis in the entrance pupil plane 21. This is indicated in FIG. 1 by the dashed extension of the chief ray 15 through the first mirror 11. Consequently, the virtual image of the aperture stop 13, the entrance pupil, lies in the entrance pupil plane 21. The exit pupil of the projection lens could likewise be found with the same construction in the backward extension of the chief ray 15 proceeding from the image plane 7. However, in the image plane 7 the chief ray 15 is parallel to the optical axis 9, and from this it follows that the backward projection of these two rays produces a point of intersection at infinity in front of the projection lens 2 and the exit pupil of the projection lens 2 is thus at infinity. Therefore, this projection lens 2 is a so-called lens that is telecentric on the image side. The center of the object field 3 is at a distance R from the optical axis 9 and the center of the image field 7 is at a distance r from the optical axis 9, in order that no undesirable vignetting of the radiation emerging from the object field occurs in the case of the reflective configuration of the projection lens.

Table 1 indicated below shows the data of an exemplary optical design in accordance with the schematic illustration in FIG. 1. In this case, the aspheres Z(h) of the mirrors 1, 11 of the optical design are specified as a function of the distance h of an asphere point of the individual mirror with respect to the optical axis in the unit [mm], in accordance with the following asphere equation:

Z(h)=(rho*h²)/(1+[1−(1+k_{y})*(rho*h)²]^{0.5})+c₁*h⁴+c₂*h⁶+c₃*h⁸+c₄*h¹⁰+c₅*h¹²+c₆*h¹⁴

with the radius R=1/rho of the mirror and the parameters k_{y}, c₁, c₂, c₃, c₄, c₅, and c₆. In this case, said parameters cₙ are normalized with regard to the unit [mm] in accordance with [1/mm²ⁿ⁺²] in such a way as to result in the asphere Z(h) as a function of the distance h also in the unit [mm].

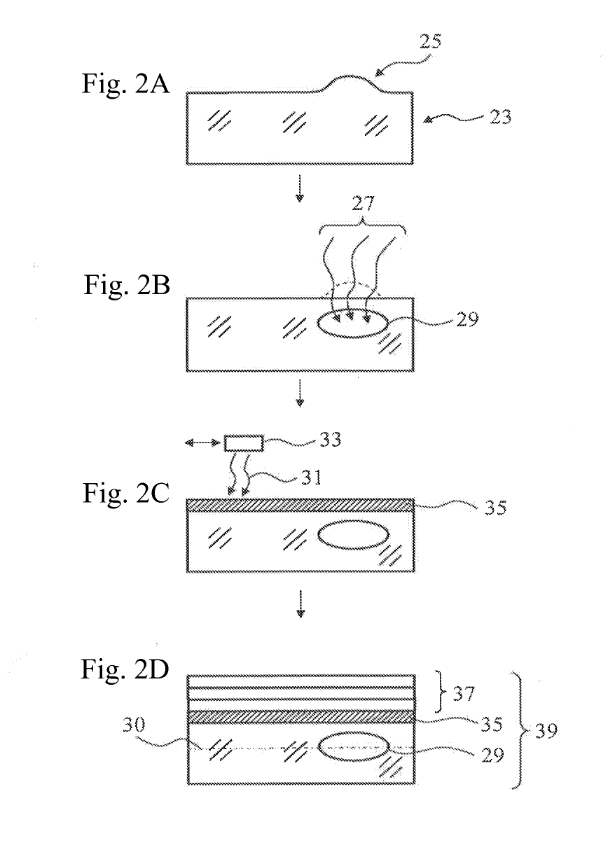

TABLE 1
Data of an optical design in accordance with the schematic illustration of the
design with reference to FIG. 1.

| Designation of | | | |
|---|---|---|---|
| the surface in | | Distance from the | Asphere parameters with the |
| accordance | | nearest surface in | unit |
| with FIG. 2 | Radius R in [mm] | [mm] | [1/mm²ⁿ⁺²] for cₙ |
| Object plane 5 | Infinity | 697.657821079643 | |
| 1st mirror 11 | −3060.189398512395 | 494.429629463009 | |
| | | | k_{y} = 0.00000000000000E+00 |
| | | | c₁ = 8.46747658600840E−10 |
| | | | c₂ = −6.38829035308911E−15 |
| | | | c₃ = 2.99297298249148E−20 |
| | | | c₄ = 4.89923345704506E−25 |
| | | | c₅ = −2.62811636654902E−29 |
| | | | c₆ = 4.29534493103729E−34 |
| 2nd mirror 11 | −1237.831140064837 | 716.403660000000 | |
| --stop-- | | | |
| | | | k_{y} = 3.05349335818189E+00 |
| | | | c₁ = 3.01069673080653E−10 |
| | | | c₂ = 3.09241275151742E−16 |
| | | | c₃ = 2.71009214786939E−20 |
| | | | c₄ = −5.04344434347305E−24 |
| | | | c₅ = 4.22176379615477E−28 |
| | | | c₆ = −1.41314914233702E−32 |
| 3rd mirror 11 | 318.277985359899 | 218.770165786534 | |
| | | | k_{y} = −7.80082610035452E−01 |
| | | | c₁ = 3.12944645776932E−10 |
| | | | c₂ = −1.32434614339199E−14 |
| | | | c₃ = 9.56932396033676E−19 |
| | | | c₄ = −3.13223523243916E−23 |
| | | | c₅ = 4.73030659773901E−28 |
| | | | c₆ = −2.70237216494288E−33 |
| 4th mirror 11 | −513.327287349838 | 892.674538915941 | |
| | | | k_{y} = −1.05007411819774E−01 |
| | | | c₁ = −1.33355977877878E−12 |
| | | | c₂ = −1.71866358951357E−16 |
| | | | c₃ = 6.69985430179187E−22 |
| | | | c₄ = 5.40777151247246E−27 |
| | | | c₅ = −1.16662974927332E−31 |
| | | | c₆ = 4.19572235940121E−37 |
| Mirror 1 | 378.800274177878 | 285.840721874570 | |
| | | | k_{y} = 0.00000000000000E+00 |
| | | | c₁ = 9.27754883183223E−09 |
| | | | c₂ = 5.96362556484499E−13 |
| | | | c₃ = 1.56339572303953E−17 |
| | | | c₄ = −1.41168321383233E−21 |
| | | | c₅ = 5.98677250336455E−25 |
| | | | c₆ = −6.30124060830317E−29 |
| 5th mirror 11 | −367.938526548613 | 325.746354374172 | |
| | | | k_{y} = 1.07407597789597E−01 |
| | | | c₁ = 3.87917960004046E−11 |
| | | | c₂ = −3.43420257078373E−17 |
| | | | c₃ = 2.26996395088275E−21 |
| | | | c₄ = −2.71360350994977E−25 |
| | | | c₅ = 9.23791176750829E−30 |
| | | | c₆ = −1.37746833100643E−34 |
| Image plane 7 | Infinity | | |

FIG. 2 schematically shows steps 2A through 2D for producing a reflective optical element according to the invention, such as, for example, a mirror 1, 11 according to the invention from FIG. 1, or a mask according to the invention from FIG. 1. In step 2A, a substrate 23 is provided and its surface form is measured by using an interferometer. The measurement by an interferometer is not illustrated in FIG. 2, for the sake of clarity. In this case, it is ascertained in step 2A that the substrate has an undesirable surface form deviation 25 from the desired surface form that is wanted. In step 2B, said surface form deviation 25 is then corrected by the densification of the substrate region 29 using an irradiation 27. In this case, appropriate irradiation 27 is an electron radiation with electrons having an energy of between 5 and 80 keV at doses of between 0.1 J/mm² and 2500 J/mm² and/or a photon irradiation with the aid of a pulsed laser having wavelengths of between 0.3 and 3 μm, repetition rates of between 1 Hz and 100 MHz and pulse energies of between 0.01 μJ and 10 mJ. This densification of the substrate region 29 results in a variation of the density of the substrate material of more than 1% by volume along an imaginary surface 30 at a fixed distance from the actual surface and which runs through the densified region 29. In this case, the variation of the density is understood to be the difference between the maximum value of the density and the minimum value of the density along said imaginary surface 30 at constant distance. Given a homogeneous irradiation of the region 29, this specification provides that the region 29 has a density that is higher by more than 1% by volume than an adjacent unirradiated region at the same distance from the surface.

Afterward, in step 2C the substrate acquires a coating with a protective layer or a protective layer subsystem, such that the substrate is protected in the long term against aging or densification by EUV radiation. Alternatively or additionally, in step 2C the substrate can be irradiated with electrons 31 from a moveable electron source 33 having an energy of between 5 and 80 keV at doses of between 0.1 J/mm² and 4000 J/mm², thus giving rise to a densified surface region 35 of the substrate which is no longer densified further by EUV radiation in the long term and is thus stable with respect to said radiation. In this case, it should be taken into consideration that, in the case of reflective optical elements, the EUV radiation has only a penetration depth into the substrate of up to 5 μm and, consequently, it is enough to sufficiently densify only this region of the substrate in proximity to the surface. Preferably, the irradiation with the aid of the electrons 31 is effected homogeneously, thus giving rise to a homogeneously densified surface region 35. Alternatively, however, it is possible to perform the irradiation and thus the densification in accordance with the distribution of the EUV radiation dose over the mirror surface that is to be expected over the lifetime sought.

Alternatively, the electron irradiation 31 in step c) can also be effected at the same time as the electron irradiation 27 in step 2B. In order that the electron irradiation 27 for surface form correction in step b) penetrates into deeper layers of the substrate as seen from the surface, it should be effected with electrons having higher energy than the electron irradiation 31 for densifying the surface region in step 2C. Conversely, it may be necessary to perform the electron irradiation 31 for densifying the surface region in step 2C with a higher dose than the electron irradiation 27 for surface form correction in step 2B, in order to achieve a saturated densification of the surface region.

As an alternative or additional protective layer in step 2C, it is possible to use layers composed of materials which have a high absorption coefficient for the EUV wavelength range; in particular, the following are suitable for this purpose: nickel, carbon, boron carbide, cobalt, beryllium, silicon, silicon oxides. In step 2C protective layer subsystems can likewise be applied to the substrate, said protective layer subsystems consisting of a periodic sequence of at least two periods of individual layers, wherein the periods comprise two individual layers composed of different materials, wherein the materials of the two individual layers forming the periods are either nickel and silicon or cobalt and beryllium. Such layer subsystems prevent the crystal growth in the absorbent metal layers and thus lead to lower roughness values of the layer system in conjunction with protection against EUV radiation that is otherwise comparable with an individual layer.

Finally, in step 2D the substrate 23 is coated with at least one layer subsystem 37 which is suitable for reflection in the EUV wavelength range and which consists of a periodic sequence of at least one period of individual layers, wherein the period comprises two individual layers having different refractive indices in the EUV wavelength range. The reflective optical element produced by steps 2A through 2D in FIG. 2 is subsequently used as an EUV mirror 1, 11 in a projection exposure apparatus or as an EUV mask.

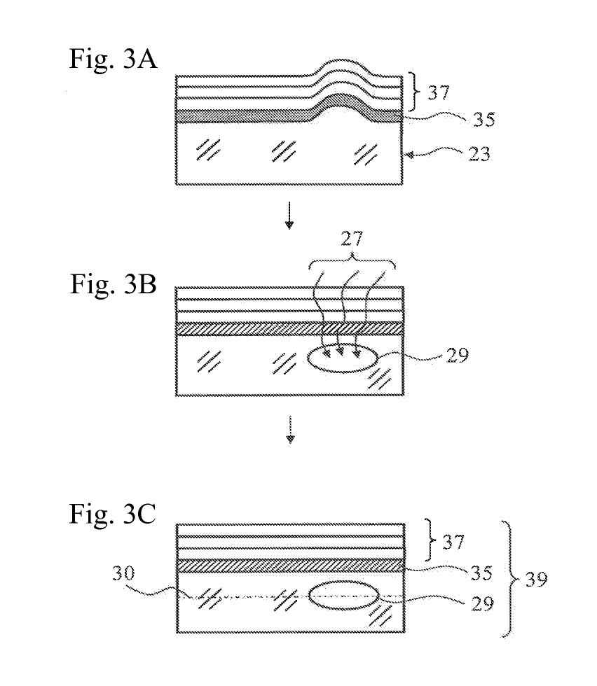

FIG. 3 schematically shows steps 3A through 3C for correcting the surface form of a reflective optical element. In this case, the layer arrangement of the optical element can already contain a protective layer or a protective layer subsystem. Furthermore, the substrate can already comprise a densified surface region 35 for protection against EUV radiation. Alternatively, said surface region 35 can be concomitantly produced at the same time during the electron irradiation for surface form correction in step 3B. In step 3A in FIG. 3, either the surface form of a reflective optical element or the wavefront of an entire projection lens is measured by with an interferometer. The measurement with an interferometer is likewise not illustrated in FIG. 3 (for the sake of clarity). In this case, it is ascertained in step a) that either the substrate has an undesirable surface form deviation from the desired surface form that is wanted, or the projection lens has an undesirable wavefront deviation from the desired wavefront that is wanted. The undesirable surface form deviation is illustrated by way of example as a hill in FIG. 33A. In step 3B, this surface form deviation or a surface form deviation corresponding to the wavefront deviation of the projection lens is then corrected by the densification of the substrate region 29 using an irradiation 27. In this case, appropriate irradiation 27 is an electron irradiation with electrons having an energy of between 5 and 80 keV at doses of between 0.1 J/mm² and 2500 J/mm², since electrons having such energies are able to penetrate through the reflective coating of the optical element. The reflective optical element corrected by steps 3A through 3C in FIG. 3 is subsequently used as an EUV mirror 1, 11 in a projection exposure apparatus or as an EUV mask. Alternatively, it is possible to correct the reflective optical element within the projection exposure apparatus using steps 3A through 3C in FIG. 3 provided that a corresponding measurement technology and a corresponding irradiation technology are present in the projection exposure apparatus. This analogously also applies to the correction of masks within a projection exposure apparatus.

Consequently, the optical element produced in accordance with steps 2A through 2D in FIG. 2 and/or the element corrected by steps 3A through 3C in FIG. 3 have/has the following features:

Reflective optical element 39 for the EUV wavelength range comprising a layer arrangement applied on the surface of a substrate, wherein the layer arrangement comprises at least one layer subsystem 37 consisting of a periodic sequence of at least one period of individual layers, wherein the period comprises two individual layers having different refractive indices in the EUV wavelength range, wherein the substrate in a surface region 35 adjoining the layer arrangement with an extent of up to a distance of 5 μm from the surface has an average density which is higher by more than 1% by volume than the average density of the substrate at a distance of 1 mm from the surface, and wherein the substrate has a variation of the density of more than 1% by volume at least along an imaginary surface 30 at a fixed distance of between 1 μm and 100 μm from the surface.

The optical element produced using steps 2A, 2B, 2D and the alternative in step 2C in FIG. 2 and/or the corresponding optical element corrected using of steps 3A through 3C in FIG. 3 have/has the following features:

Reflective optical element 39 for the EUV wavelength range comprising a layer arrangement applied on the surface of a substrate, wherein the layer arrangement comprises at least one layer subsystem 37 consisting of a periodic sequence of at least one period of individual layers, wherein the period comprises two individual layers having different refractive indices in the EUV wavelength range, wherein the layer arrangement comprises at least one protective layer or at least one protective layer subsystem having a thickness of greater than 20 nm, in particular 50 nm, such that the transmission of EUV radiation through the layer arrangement is less than 10%, in particular less than 2%, and wherein the substrate has a variation of the density of more than 1% by volume at least along an imaginary surface 30 at a fixed distance of between 0 μm and 100 μm from the surface.

In all of the optical elements the variation of the density is produced with the aid of electrons having an energy of between 5 and 80 keV at doses of between 0.1 J/mm² and 2500 J/mm² and/or with the aid of a pulsed laser having wavelengths of between 0.3 and 3 μm, repetition rates of between 1 Hz and 100 MHz and pulse energies of between 0.01 μJ and 10 mJ.

1. Reflective optical element for the extreme ultraviolet (EUV) wavelength range comprising a layer arrangement applied on a surface of a substrate,
wherein the layer arrangement comprises at least one layer subsystem consisting of a periodic sequence of at least one period of individual layers, wherein the period comprises two individual layers having different refractive indices in the EUV wavelength range,
wherein the substrate in a surface region adjoining the layer arrangement and extending into the substrate up to a distance of 5 μm from the surface has an average density which is higher by more than 1% by volume than an average density of a region of the substrate extending into the substrate a distance of 1 mm from the surface, and
wherein the substrate has a variation of the density of more than 1% by volume at least along an imaginary surface at a fixed distance of between 1 μm and 100 μm from the surface.

2. Reflective optical element according to claim 1, wherein the average density in the surface region extending into the substrate up to a distance of 1 μm from the surface is higher by more than 2% by volume than the average density of the region of the substrate extending into the substrate a distance of 1 mm from the surface.

3. Reflective optical element for the EUV wavelength range comprising a layer arrangement applied on a surface of a substrate,
wherein the layer arrangement comprises at least one layer subsystem consisting of a periodic sequence of at least one period of individual layers, wherein the period comprises two individual layers having different refractive indices in the EUV wavelength range,
wherein the layer arrangement comprises at least one of at least one protective layer and at least one protective layer subsystem having a thickness of greater than 20 nm, such that the transmission of EUV radiation through the layer arrangement is less than 10%, and
wherein the substrate has a variation of the density of more than 1% by volume at least along an imaginary surface at a fixed distance of between 0 μm and 100 μm from the surface.

4. Reflective optical element for the EUV wavelength range according to claim 3, wherein the layer arrangement comprises at least one layer formed individually from a material or as a compound from materials of the group: nickel, carbon, boron carbide, cobalt, beryllium, silicon, and silicon oxides.

5. Reflective optical element for the EUV wavelength range according to claim 3, wherein the layer arrangement comprises at least one protective layer subsystem consisting of a periodic sequence of at least two periods of individual layers, wherein the periods comprise two individual layers composed of different materials, and
wherein the materials of the two individual layers forming the periods are either nickel and silicon or cobalt and beryllium.

6. Reflective optical element for the EUV wavelength range according to claim 1, wherein the substrate has a variation of the density of more than 2% by volume at least along the imaginary surface at a fixed distance of between 1 μm and 5 μm from the surface.

7. Reflective optical element for the EUV wavelength range according to claim 1, wherein the substrate consists of a material having an SiO₂ proportion of at least 40% by volume up to a distance of 1 mm from the surface.

8. Reflective optical element for the EUV wavelength range according to claim 1, wherein the variation of the density is produced with at least one of: electrons having an energy of between 5 and 80 keV at doses of between 0.1 J/mm² and 2500 J/mm², and a pulsed laser having wavelengths of between 0.3 and 3 μm, repetition rates of between 1 Hz and 100 MHz and pulse energies of between 0.01 μJ and 10 mJ.

9. Method for producing a reflective optical element according to claim 1, comprising:
a) measuring the substrate surface with an interferometer;
b) irradiating the substrate with at least one of electrons having an energy of between 5 and 80 keV at doses of between 0.1 J/mm² and 2500 J/mm², and a pulsed laser having wavelengths of between 0.3 and 3 μm, repetition rates of between 1 Hz and 100 MHz and pulse energies of between 0.01 μJ and 10 mJ;
c) at least one of: coating the substrate with a protective layer or a protective layer subsystem, and irradiating the substrate with the aid of electrons having an energy of between 5 and 80 keV at doses of between 0.1 J/mm² and 4000 J/mm² and
d) coating the substrate with at least one layer subsystem configured for the EUV wavelength range.

10. Method according to claim 9, wherein a higher energy of the electrons is used when irradiating the substrate with electrons in step b) than when irradiating the substrate with electrons in step c).

11. Method for correcting the surface form of a reflective optical element according to claim 1, further comprising:
a) at least one of: measuring the reflective optical element with an interferometer, and measuring a projection lens comprising the reflective optical element with an interferometer; and
b) irradiating the reflective optical element with electrons having an energy of between 5 and 80 keV at doses of between 0.1 J/mm² and 2500 J/mm².

12. Projection lens for microlithography comprising a mirror as reflective optical element according to claim 1.

13. Projection exposure apparatus for microlithography comprising a projection lens according to claim 12.

14. Reflective optical element according to claim 3,
wherein the at least one of the at least one protective layer and the at least one protective layer subsystem has a thickness of greater than 50 nm, such that the transmission of EUV radiation through the layer arrangement is less than 2% and
wherein the substrate has a variation of the density of more than 1% by volume at least along an imaginary surface at a fixed distance of between 0 μm and 100 μm from the surface.

15. Reflective optical element for the EUV wavelength range according to claim 3, wherein the substrate has a variation of the density of more than 2% by volume at least along the imaginary surface at a fixed distance of between 1 μm and 5 μm from the surface.

16. Reflective optical element for the EUV wavelength range according to claim 3, wherein the substrate consists of a material having an SiO₂ proportion of at least 40% by volume up to a distance of 1 mm from the surface.

17. Reflective optical element for the EUV wavelength range according to claim 3, wherein the variation of the density is produced with at least one of: electrons having an energy of between 5 and 80 keV at doses of between 0.1 J/mm² and 2500 J/mm², and a pulsed laser having wavelengths of between 0.3 and 3 μm, repetition rates of between 1 Hz and 100 MHz and pulse energies of between 0.01 μJ and 10 mJ.

18. Method for producing a reflective optical element according to claim 3, comprising:
a) measuring the substrate surface with an interferometer;
b) irradiating the substrate with at least one of electrons having an energy of between 5 and 80 keV at doses of between 0.1 J/mm² and 2500 J/mm², and a pulsed laser having wavelengths of between 0.3 and 3 μm, repetition rates of between 1 Hz and 100 MHz and pulse energies of between 0.01 μl and 10 mJ;
c) at least one of: coating the substrate with a protective layer or a protective layer subsystem, and irradiating the substrate with the aid of electrons having an energy of between 5 and 80 keV at doses of between 0.1 J/mm² and 4000 J/mm² and
d) coating the substrate with at least one layer subsystem configured for the EUV wavelength range.

19. Method for correcting the surface form of a reflective optical element according to claim 3, further comprising:
a) at least one of: measuring the reflective optical element with an interferometer, and measuring a projection lens comprising the reflective optical element with an interferometer; and
b) irradiating the reflective optical element with electrons having an energy of between 5 and 80 keV at doses of between 0.1 J/mm² and 2500 J/mm².

20. Projection lens for microlithography comprising a mirror as reflective optical element according to claim 3.
